(19) United States
(12) Patent Application Publication
(10) Pub. No.: US 2022/0021026 A1
(43) Pub. Date: Jan. 20, 2022

(54) FLUORINATED GEL POLYMER ELECTROLYTE FOR A LITHIUM ELECTROCHEMICAL CELL

(71) Applicant: SOLVAY SA, Brussels (BE)

(72) Inventors: Guillaume MÜLLER, Woluwe-Saint-Pierre (BE); Lawrence Alan HOUGH, Mapo-gu, Seoul (KR); Hyun-Cheol LEE, Yeongtong-gu, Suwon-si, Gyeonggi-do (KR); So-young LEE, Seodaemun-gu Seoul (KR); Ji-Hye WON, Yeongdeungpo-gu, Seoul (KR)

(21) Appl. No.: 17/312,421

(22) PCT Filed: Dec. 11, 2019
(86) PCT No.: PCT/EP2019/084678

§ 371 Date: Jun. 10, 2021

(30) Foreign Application Priority Data
Dec. 21, 2018 (EP) 18215613.3

(51) Int. Cl. H01M 10/0565; H01M 10/0525; H01M 10/0568; H01M 10/0569; H01M 10/0567

(52) U.S. Cl. CPC H01M 10/0565; H01M 10/0525; H01M 2300/0082; H01M 10/0569; H01M 10/0567; H01M 10/0568

(57) ABSTRACT

A gel polymer electrolyte for a lithium electrochemical cell, comprising: a) a three-dimensional cross-linked polymer network within a liquid electrolyte obtained by forming a reaction product of at least one fluorinated copolymer with at least one isocyanate compound comprising at least two isocyanate functional groups, and b) a liquid electrolyte solution included in the polymer network a), wherein the fluorinated copolymer comprises: i) at least one first recurring unit derived from at least one ethylenically unsaturated fluorinated monomer; and ii) at least one second recurring unit derived from at least one ethylenically unsaturated monomer having a hydroxyl group. A process for the manufacture of the gel polymer electrolyte for a lithium electrochemical cell; a lithium electrochemical cell comprising a cathode, an anode, and the present gel polymer electrolyte; and use of the gel electrolyte polymer in a lithium electrochemical cell as a separator and an electrolyte.

### CROSS-REFERENCE TO RELATED APPLICATION

The present application claims priority to European application No. 18215613.3 filed on Dec. 21, 2018, the whole content of this application being incorporated herein by reference. Should the disclosure of any patents, patent applications, and publications which are incorporated herein by reference conflict with the description of the present application to the extent that it may render a term unclear, the present description shall take precedence.

### TECHNICAL FIELD

The present invention relates to a gel polymer electrolyte for a lithium electrochemical cell, to a process for its manufacturing, to its use as a separator and an electrolyte in an electrochemical cell, and to a lithium electrochemical cell comprising the gel polymer electrolyte.

### BACKGROUND OF THE INVENTION

An electrolyte is a substance which produces an electrically conducting solution, when it is dissolved in a polar solvent. The dissolved electrolyte splits into cations and anions, which disperse through the solvent in a uniform manner. Such a solution is electrically neutral, but if an electrical potential is applied, the cations in the solution move to the electrode having abundant electrons, whereas the anions move to the electrode having a deficit of electrons. That is, the movement of cations and anions in opposite directions results in an electrical current.

Basic requirements of a suitable electrolyte for an electrochemical cell include high ionic conductivity, low melting and high boiling points, (electro)chemical stability and also safety, among which electrochemical stability and high ionic conductivity are the most important parameters in selecting an electrolyte for an electrochemical cell.

The conventional electrolyte, which is in liquid, has played an essential and dominant role in the field of an electrochemical energy storage for several decades due to its high ionic conductivity and good interface with electrodes. However, such a liquid electrolyte has brought safety issues caused by its leakage and inherent explosive nature, e.g., combustion of the organic electrolyte.

Another drawback of a liquid electrolyte in lithium batteries is that lithium dendrites grow inevitably in the liquid solution due to uneven currents when charged in the case of a porous separator.

A solid polymer electrolyte, without liquid solvents, has been investigated as a promising alternative to a liquid electrolyte so as to tackle the safety issues and to prohibit the growth of lithium dendrites. However, a solid polymer electrolyte exhibits low ionic conductivities and poor interface with electrodes, resulting in the deterioration of the cycle performance. Its inferior mechanical properties has also limited its further development.

Accordingly, the quest for a new electrolyte system, which is safer and more reliable than liquid and solid electrolytes, has continuously existed in the field. To this end, a gel polymer electrolyte has attracted widespread attention due to its superior features including safety, flexibility, light-weight, reliability, versatility in shape, etc., which combined the advantages of both liquid and solid electrolytes.

Numerous gel polymer electrolyte systems have been developed since G. Feuillade and P. Perche disclosed in 1975 a plasticized polyacrylonitrile (PAN) with an aprotic solution containing an alkali metal salt in the Journal of Applied Electrochemistry (Volume 5, Issue 1, February 1975, Pages 63-69). However, GPE systems have several drawbacks including the deterioration of the mechanical strength, which is considered to be caused by the incorporation of an organic liquid electrolyte into the polymer matrix.

US Patent publication No. 2013/0023620 (Solvay Specialty Polymers Italy S.P.A.) discloses a hybrid inorganic-organic polymer which contains metal alkoxide, such as tetraethylorthosilicate (TEOS), as precursors for the inorganic part. Such a hybrid polymer exhibits combined advantageous properties of both fluorinated polymers and hydrogenated polymers, as an alternative electrolyte system. Usually, fluorinated polymers have numerous valuable properties including thermal stability, chemical stability and mechanical strength, but suffers from high water repellency. To the contrary, hydrogenataed polymers exhibit high affinity with water, but suffer from high flammability and low oil repellency. The hybrid inorganic-organic polymer provides solutions for such drawbacks. However, it requires the presence of water to condense the inorganic part, which eventually becomes problematic to be used in a lithium electrochemical cell, because lithium salt, which is an essential element in the lithium electrochemical cell, is sensitive to the moisture.

Accordingly, a strong demand still exists for a new gel polymer electrolyte system which exhibits high ionic conductivity, excellent chemical stability, good thermal stability and good mechanical performance, as well as a simple preparation method of a gel polymer electrolyte.

The gel polymer electrolyte according to the present invention solves the issue in view of mechanical strength, while maintaining other positive features. Moreover, the present gel polymer electrolyte may function not only as an electrolyte, but also as a separator, so that the presence of a separator is not required with this present gel polymer electrolyte system.

### SUMMARY OF THE INVENTION

The present invention provides a gel polymer electrolyte for a lithium electrochemical cell comprising: a) a three-dimensional cross-linked polymer obtained by forming a reaction product of at least one fluorinated copolymer with at least one isocyanate compound comprising at least two isocyanate functional groups; and
b) a liquid electrolyte solution comprised in a) the polymer network, wherein the fluorinated copolymer comprises
i) at least one first recurring unit derived from at least one ethylenically unsaturated fluorinated monomer; and
ii) at least one second recurring unit derived from at least one ethylenically unsaturated monomer having a hydroxyl group.

One of the essential features of the present invention is that the polymer network according to the present invention comprises at least one urethane moiety bridging at least two fluorinated copolymers. The presence of urethane moieties within the polymer network brings out improvement of its mechanical strength.

The present invention also includes a process for the manufacture of a gel polymer electrolyte for a lithium electrochemical cell, said process comprising
dissolving at least one fluorinated copolymer in a volatile solvent;
reacting the fluorinated copolymer dissolved in a volatile solvent with at least one isocyanate compound comprising at least two isocyanate functional groups, while adding at least one liquid electrolyte solution and optionally at least one additive (e.g. a film-forming additive) to produce a polymer network;
casting the polymer network containing the liquid electrolyte onto a substrate; and
removing the volatile solvent to produce a gel polymer electrolyte.

The gel polymer electrolyte according to the present invention may be used with or without a separator in an electrochemical cell.

The present invention also relates to a lithium electrochemical cell comprising a cathode, an anode, and the present gel polymer electrolyte.

The capacity of a battery corresponds to the amount of electric charge it may deliver at the rated voltage, which is measured in units of ampere-hour (A-h), and is decided by the amount of electrochemically active materials within the battery. Usually, a gravimetric specific capacity, such as A-h/kg or mA-h/g, is used to express the energy density in a battery. Larger A-h/g defines higher density.

Indeed, it was surprisingly found by the inventors that the use of a gel polymer electrolyte according to the present invention; i.e., a gel polymer electrolyte containing a) a polymer network obtained by forming a reaction product of at least one fluorinated copolymer with at least one isocyanate compound comprising at least two isocyanate functional groups, and b) a liquid electrolyte solution impregnated into the polymer network, in a lithium electrochemical cell solves one of the drawbacks of gel polymer electrolyte systems previously developed, i.e., the degradation of mechanical performance, while maintaining other benefits of gel polymer electrolyte systems comprising high ionic conductivity, excellent chemical stability and good thermal stability. It was clearly demonstrated in terms of the capacity as a function of the cycle number of the electrochemical cells.

It is believed that the presence of urethane moiety within the polymer network, which is the reaction product between the hydroxyl group within the second recurring unit of the fluorinated copolymer and the isocyanate functional group, contributes to the enhancement of mechanical strength of the gel polymer electrolyte according to the present invention by bridging at least two fluorinated copolymers.

### BRIEF DESCRIPTION OF THE FIGURE

FIG. 1 shows on the left ordinate axis the variation of the capacity as a function of the cycle number of the electrochemical cells for the Inventive Example (E1) and Comparative Examples (CE1 and CE2).

### DETAILED DESCRIPTION OF THE INVENTION

A first object of the present invention is a gel polymer electrolyte for a lithium electrochemical cell comprising:
a) a three-dimensional cross-linked polymer network obtained by forming a reaction product of at least one fluorinated copolymer with at least one isocyanate compound comprising at least two isocyanate functional groups, and
b) a liquid electrolyte solution comprised in a) the polymer network, wherein the fluorinated copolymer comprises
i) at least one first recurring unit derived from at least one ethylenically unsaturated fluorinated monomer; and
ii) at least one second recurring unit derived from at least one ethylenically unsaturated monomer having a hydroxyl group.

In the present invention, the term “fluorinated copolymer” is intended to denote a copolymer, wherein at least one hydrogen atom is replaced by fluorine. One, two, three or a higher number of hydrogen atoms may be replaced by fluorine.

The reaction product of at least one fluorinated copolymer with at least one isocyanate compound comprising at least two isocyanate functional groups comprises urethane moiety, which is intended to denote a moiety having the formula:

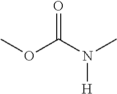

One of the essential features of the present invention is that a) the polymer network according to the present invention comprises at least one urethane moiety bridging at least two fluorinated copolymers. The presence of urethane moieties within the polymer network brings out improvement of its mechanical strength.

In one embodiment, the polymer network accounts from 10.0 to 40.0 wt %, preferably from 15.0 to 35.0 wt %, and more preferably from 20.0 to 30.0 wt %, based on the total weight of the gel polymer electrolyte.

Polyvinylidenefluoride (PVDF or VDF polymer) is one of the most widely used fluoropolymers in battery components, due to its high anodic stability and high dielectric constant, which favours the ionisation of lithium salts in lithium-ion batteries and enables the flow of ions, resulting in the improvement of the cell performance.

According to one embodiment, i) the first recurring unit is derived from vinylidene fluoride (VDF), chlorotrifluoroethylene (CTFE), hexafluoropropylene (HFP), tetrafluoroethylene (TFE), trifluoroethylene, and combinations thereof.

In one embodiment, the fluorinated copolymer of the present invention comprises two first recurring units derived from at least one ethylenically unsaturated fluorinated monomer. In a specific embodiment, said two first recurring units are VDF and CTFE. In another specific embodiment, said two first recurring units are VDF and TFE. In a preferred embodiment, said two first recurring units are VDF and HFP.

In one embodiment, i) the first recurring unit according to the present invention is VDF (co)polymer.

In the present invention, the VDF polymer refers to a polymer essentially made of the recurring units, more than 85% by moles of said recurring units being derived from VDF.

The VDF polymer is preferably a polymer comprising

(a) at least 85% by moles of the recurring units derived from VDF;

(b) optionally from 0.1 to 15%, preferably from 0.1 to 12%, more preferably from 0.1 to 10% by moles of the recurring units derived from a fluorinated monomer different from VDF; and

(c) optionally from 0.1 to 5%, by moles, preferably 0.1 to 3% by moles, more preferably 0.1 to 1% by moles of the recurring units derived from one or more hydrogenated comonomers,

wherein all the aforementioned % by moles is referred to the total moles of recurring units of the VDF polymer.

Non-limiting examples of suitable fluorinated monomer as i) the first recurring unit, different from VDF, include, notably, the followings.
C₂-C₈ perfluoroolefins, such as tetrafluoroethylene and hexafluoropropylene (HFP);
C₂-C₈ hydrogenated fluoroolefins, such as vinyl fluoride, 1,2-difluoroethylene and trifluoroethylene;
perfluoroalkylethylenes of formula CH₂═CH—R_{f0}, wherein R_{f0} is a C₁-C₆ perfluoroalkyl;
chloro- and/or bromo- and/or iodo-C₂-C₆ fluoroolefins such as chlorotrifluoroethylene;
(per)fluoroalkylvinylethers of formula CF₂═CFOR_{f1}, wherein R_{f1} is a C₁-C₆ fluoro- or perfluoroalkyl, e.g. CF₃, C₂F₅, C₃F₇;
CF₂═CFOX₀ (per)fluoro-oxyalkylvinylethers wherein Xo is a C₁-C₁₂ alkyl group, a C₁-C₁₂ oxyalkyl group or a C₁-C₁₂ (per)fluorooxyalkyl group having one or more ether groups, such as perfluoro-2-propoxy-propyl group;
(per)fluoroalkylvinylethers of formula CF₂═CFOCF₂OR_{f2}, wherein R_{f2} is a C₁-C₆ fluoro- or perfluoroalkyl group, e.g. CF₃, C₂F₅, C₃F₇ or a C₁-C₆ (per)fluorooxyalkyl group having one or more ether groups such as —C₂F₅—O—CF₃;
functional (per)fluoro-oxyalkylvinylethers of formula CF₂═CFOY₀, wherein Y₀ is a C₁-C₁₂ alkyl group or (per)fluoroalkyl group, a C₁-C₁₂ oxyalkyl group or a C₁-C₁₂ (per)fluorooxyalkyl group having one or more ether groups and Y₀ comprising a carboxylic or sulfonic acid group, in its acid, acid halide or salt form; and
fluorodioxoles, preferably perfluorodioxoles.

In a preferred embodiment, said fluorinated monomer as i) the first recurring unit is advantageously selected from the group consisting of vinyl fluoride, trifluoroethylene, chlorotrifluoroethylene (CTFE), 1,2-difluoroethylene, tetrafluoroethylene (TFE), hexafluoropropylene (HFP), perfluoro(alkyl)vinyl ethers, such as perfluoro(methyl)vinyl ether (PMVE), perfluoro(ethyl) vinyl ether (PEVE) and perfluoro(propyl)vinyl ether (PPVE), perfluoro(1,3-dioxole), perfluoro(2,2-dimethyl-1,3-dioxole) (PDD). Preferably, the possible additional fluorinated monomer is selected from the group consisting of chlorotrifluoroethylene (CTFE), hexafluoroproylene (HFP), trifluoroethylene (TrFE) and tetrafluoroethylene (TFE).

In a more preferred embodiment, the fluorinated monomer is hexafluoropropylene (HFP).

In another embodiment, as non-limitative examples of the VDF (co)polymers as i) the first recurring unit of the fluorinated copolymer in the present invention, mention can be notably made of homopolymers of VDF, VDF/TFE copolymers, VDF/TFE/HFP copolymers, VDF/TFE/CTFE copolymers, VDF/TFE/TrFE copolymers, VDF/CTFE copolymers, VDF/IFP copolymers, VDF/TFE/HIFP/CTFE copolymers, and the like. In particular, VDF/IFP copolymers have been attracting considerable attention due to its good compatibility with the electrodes, its low transition temperature and crystallinity, which enable to improve the ionic conductivity.

Said hydrogenated comonomer is not particularly limited; alpha-olefins, (meth)acrylic monomers, vinyl ether monomers, and styrenic mononomers may be used.

Accordingly, the VDF polymer is more preferably a polymer consisting essentially of:

(a) at least 85% by moles of recurring units derived from VDF;

(b) optionally from 0.1 to 15%, preferably from 0.1 to 12%, more preferably from 0.1 to 10% by moles of a fluorinated monomer different from VDF; said fluorinated monomer being preferably selected in the group consisting of vinylfluoride, chlorotrifluoroethylene (CTFE), hexafluoropropene (HFP), tetrafluoroethylene (TFE), perfluoromethylvinylether (MVE), trifluoroethylene (TrFE) and mixtures therefrom,

wherein all the aforementioned % by moles is referred to the total moles of recurring units of the VDF polymer.

Defects, end chains, impurities, chain inversions or branchings and the like may be additionally present in the VDF polymer in addition to the said recurring units, without these components substantially modifying the behaviour and properties of the VDF polymer.

According to one embodiment, ii) the second recurring unit is derived from an (meth)acrylic acid ester having a hydroxyl group.

According to one embodiment, the (meth)acrylic acid ester having a hydroxyl group comprises 2-hydroxyethyl acrylate (HEA), 2-hydroxyethyl methacrylate, 2-hydroxymethyl acrylate, 2-hydroxymethyl methacrylate, 2-hydroxypropyl acrylate, 2-hydroxypropyl methacrylate, 2-hydroxybutyl acrylate, 2-hydroxybutyl methacrylate, 4-hydroxybutyl acrylate, 4-hydroxybutyl methacrylate, 6-hydroxyhexyl acrylate, 6-hydroxyhexyl methacrylate, 8-hydroxyoctyl acrylate, 8-hydroxyoctyl methacrylate, 2-hydroxyethyleneglycol acrylate, 2-hydroxyethlyeneglycol methacrylate, 2-hydroxypropyleneglycol acrylate, 2-hydroxypropyleneglycol methacrylate, 2,2,2-trifluoroethyl acrylate, and 2,2,2-trifluoroethyl methacrylate.

In a preferred embodiment, ii) the second recurring unit is HEA.

In one embodiment, the fluorinated copolymer comprises from 0.1 to 20.0% by moles, preferably from 0.1 to 15.0% by moles, more preferably from 0.1 to 10.0% by moles of ii) the second recurring unit derived from at least one ethylenically unsaturated monomer having a hydroxyl group.

In a preferred embodiment, the fluorinated copolymer comprises:
from 90.0 to 99.9% by moles of i) the first recurring unit derived from at least one ethylenically unsaturated fluorinated monomer
from 0.1 to 10.0% by moles of ii) the second recurring unit derived from at least one ethylenically unsaturated monomer having a hydroxyl group.

In a more preferred embodiment, the fluorinated copolymer comprises:
from 80.0 to 99.8% by moles of VDF and from 0.1 to 10.0% by moles of HFP as i) the first recurring units derived from at least one ethylenically unsaturated fluorinated monomer; and
from 0.1 to 10.0% by moles of HEA as ii) the second recurring unit derived from at least one ethylenically unsaturated monomer having a hydroxyl group.

According to one embodiment, the at least one isocyanate compound comprising at least two isocyanate functional groups include, but not limited to 2,4-tolylenediisocyanate, 2,6-tolylenediisocyanate, xylylenediisocyanate, isophoronediisocyanate, methylene bis(4-phenyl isocyanate), methyl cyclohexyldiisocyanate, trimethyl hexamethylene diisocyanate, hexamethylene diisocyanate, naphthalene-1,5-diisocyanate, and poly(ethylene adipate)-tolylene-2,4,-diisocyanate.

In one embodiment, a mole ratio of the ii) at least one second recurring unit derived from at least one ethylenically unsaturated monomer having a hydroxyl group to the at least one isocyanate compound comprising at least two isocyanate functional groups is about 3:1, and preferably about 2:1.

In the present invention, b) the liquid electrolyte solution comprises at least one lithium salt and a liquid medium comprising at least one organic carbonate compound.

In the present invention, the term “liquid medium” is intended to denote a medium comprising at least one substances in the liquid state at 20□ under atmospheric pressure.

In one embodiment, b) the liquid electrolyte solution comprises at least 65.0 wt %, preferably at least 75.0 wt %, more preferably at least 85.0 wt %, even more preferably at least 95.0 wt % of the liquid medium.

In another embodiment, b) the liquid electrolyte solution comprises at least 99.5 wt % of the liquid medium.

In the present invention, the organic carbonate compound may be partially or fully fluorinated carbonate compound. The organic carbonate compound according to the present invention may be either cyclic carbonate or acyclic carbonate.

Non-limiting examples of the organic carbonate compound include, notably, ethylene carbonate (1,3-dioxolan-2-one), propylene carbonate, 4-methylene-1,3-dioxolan-2-one, 4,5-dimethylene-1,3-dioxolan-2-one, dimethyl carbonate, diethyl carbonate, ethyl methyl carbonate, dipropyl carbonate, methyl propyl carbonate, methyl butyl carbonate, ethyl butyl carbonate, propyl butyl carbonate, dibutyl carbonate, di-tert-butyl carbonate and butylene carbonate.

The fluorinated carbonate compound may be mono-fluorinated or polyfluorinated. Suitable examples of the fluorinated carbonate compound comprises, but not limited to, mono- and difluorinated ethylene carbonate, mono- and difluorinated propylene carbonate, mono- and difluorinated butylene carbonate, 3,3,3-trifluoropropylene carbonate, fluorinated dimethyl carbonate, fluorinated diethyl carbonate, fluorinated ethyl methyl carbonate, fluorinated dipropyl carbonate, fluorinated dibutyl carbonate, fluorinated methyl propyl carbonate, and fluorinated ethyl propyl carbonate.

In one embodiment, the organic carbonate compound is monofluorinated ethylene carbonate (4-fluoro-1,3-dioxolan-2-one).

In another embodiment, the organic carbonate compound is a mixture of ethylene carbonate and propylene carbonate.

In one embodiment, b) the at least one liquid electrolyte solution comprises from 35.0 to 96.0 wt %, preferably from 50.0 to 93.0 wt %, and more preferably from 85.0 to 90.0 wt % of the at least one organic carbonate compound. In the present invention, the lithium salt is intended to denote, in particular, a lithium ion complex comprising, but not limited to, lithium trifluoromethane sulfonate (LiCF₃SO₃), lithium hexafluorophosphate (LiPF₆), lithium bis(fluorosulfonyl)imide Li(FSO₂)₂N (LiFSI), LiN(SO₂CₘF₂ₘ₊₁)(SO₂CₙF₂ₙ₊₁) and LiC(SO₂CₖF₂ₖ₊₁)(SO₂CₘF₂ₘ₊₁)(SO₂CₙF₂ₘ₊₁) wherein k=1-10, m=1-10 and n=1-10, LiN(SO₂CₚF₂ₚSO₂) and LiC(SO₂CₚF₂ₚSO₂)(SO₂C_{q}F_{2q+1}) wherein p=1-10 and q=1-10, lithium perchlorate (LiClO₄), lithium hexafluoroarsenate (LiAsF₆), lithium hexafluoroantimonate (LiSbF₆), lithium hexafluorotantalate (LiTaF₆), lithium tetrachloroaluminate (LiAlCl₄), lithium tetrafluoroborate (LiBF₄), lithium chloroborate (Li₂B₁₀Cl₁₀), lithium fluoroborate (Li₂B₁₀F₁₀), Li₂B₁₂FₓH₁₂₋ₓ wherein x=0-12; LiPFₓ(R_{F})₆₋ₓ and LiBF_{y}(R_{F})_{4-y} wherein R_{F} represents perfluorinated C₁-C₂₀ alkyl groups or perfluorinated aromatic groups, x=0-5 and y=0-3, LiBF₂[O₂C(CX₂)ₙCO₂], LiPF₂[O₂C(CX₂)ₙCO₂]₂, LiPF₄[O₂C(CX₂)ₙCO₂] wherein X is selected from the group consisting of H, F, Cl, C₁-C₄ alkyl groups and fluorinated alkyl groups, and n=0-4, lithium salts of chelated orthoborates and chelated orthophosphates such as lithium bis(oxalato)borate [LiB(C₂O₄)₂], lithium bis(malonato)borate [LiB(O₂CCH₂CO₂)₂], lithium bis(difluoromalonato) borate [LiB(O₂CCF₂CO₂)₂], lithium (malonatooxalato) borate [LiB(C₂O₄)(O₂CCH₂CO₂)], lithium (difluoromalonatooxalato) borate [LiB(C₂O₄)(O₂CCF₂CO₂)], lithium tris(oxalato) phosphate [LiP(C₂O₄)₃], lithium tris(difluoromalonato) phosphate [LiP(O₂CCF₂CO₂)₃], lithium difluorophosphate (LiPO₂F₂), and mixtures thereof.

The preferred lithium salts are lithium hexafluorophosphate (LiPF₆), lithium bis(fluorosulfonyl)imide Li(FSO₂)₂N (LiFSI), lithium trifluoromethane sulfonate (LiCF₃SO₃), LiN(SO₂CₘF₂ₘ₊₁)(SO₂CₙF₂ₙ₊₁) and LiC(SO₂CₖF₂ₖ₊₁)(SO₂CₘF₂ₘ₊₁)(SO₂CₙF₂ₘ₊₁) wherein k=1-10, m=1-10 and n=1-10, LiN(SO₂CₚF₂ₚSO₂) and LiC(SO₂CₚF₂ₚSO₂)(SO₂C_{q}F_{2q+1}) wherein p=1-10 and q=1-10, and mixtures thereof.

The concentration of the lithium salt generally ranges from 0.1 to 4 mol per liter of the electrolyte composition, preferably from 0.0 to 3 mol per liter of the electrolyte composition, and is typically about 1 mol per liter of the electrolyte composition.

According to one embodiment, b) at least one liquid electrolyte solution further comprises at least one additive, in particular a film-forming additive, which promotes the formation of the solid electrolyte interface (SEI) layer at the anode surface and/or cathode surface by reacting in advance of the solvents on the electrode surfaces. Main components of SEI hence comprise the decomposed products of electrolyte solvents and salts, which include Li₂CO₃, lithium alkyl carbonate, lithium alkyl oxide and other salt moieties such as LiF for LiPF₆-based electrolytes. Usually, the reduction potential of the film-forming additive is higher than that of solvent when reactions occurs at the anode surface, and the oxidation potential of the film-forming additive is lower than that of solvent when reaction occurs at the cathode side.

For the sake of clarity, the film-forming additive of the present invention differs from the organic carbonate compound of b) the liquid electrolyte solution. Examples of a film-forming additive include, but not limited to, salts based on tetrahedral boron compounds comprising lithium(bisoxalatoborate) (LiBOB) and lithium difluorooxalato borate (LiDFOB); cyclic sulphites and sulfate compounds comprising 1,3-propanesultone (PS), ethylene sulphite (ES) and prop-1-ene-1,3-sultone (PES); sulfone derivatives comprising dimethyl sulfone, tetrametylene sulfone (also known as sulfolane), ethyl methyl sulfone and isopropyl methyl sulfone; nitrile derivatives comprising succinonitrile, adiponitrile glutaronitirle and 4,4,4-trifluoronitrile; and vinyl acetate (VA), biphenyl benzene, isopropyl benzene, hexafluorobenzene, lithium nitrate (LiNO₃), tris(trimethylsilyl)phosphate, triphenyl phosphine, ethyl diphenylphosphinite, triethyl phosphite, vinylene carbonate (VC), vinyl ethylene carbonate (VEC), ethyl propyl vinylene carbonate, dimethyl vinylene carbonate, maleic anhydride (MA), allyl ether carbonate (AEC), catechol carbonate, fluoroethylene carbonate, difluoroethylene carbonate, tris(2,2,2-trifluoroethyl) phosphite, fluorinated carbamate, and mixtures thereof.

In one preferred embodiment, the film-forming additive is vinylene carbonate.

In the present invention, the total amount of the film-forming additive(s) may be from 0 to 30 wt %, preferably from 0 to 20 wt %, more preferably from 0 to 15 wt %, and even more preferably from 0 to 5 wt % with respect to the total weight of b) the liquid electrolyte solution. The total amount of the film-forming additive(s), if contained in the liquid electrolyte solution of the present invention, may be from 0.1 to 15.0 wt %, preferably from 0.5 to 5.0 wt % with respect to the total weight of b) the liquid electrolyte solution.

In a preferred embodiment, the total amount of film-forming additive(s) accounts for at least 1.0 wt % of b) the liquid electrolyte solution.

In a more preferred embodiment of the present invention, b) the liquid electrolyte solution comprises
LiPF₆ as a lithium salt;
from 85.0 to 90.0 wt % of at least one cyclic carbonate compound; and
from 1.0 to 5.0 wt % of a film-forming additive.

A second object of the present invention is a process for the manufacture of the gel polymer electrolyte for a lithium electrochemical cell, said process comprising the steps of:
a) dissolving at least one fluorinated copolymer in a volatile solvent;
b) mixing the dissolved polymer solution with a liquid electrolyte;
c) reacting the resulting solution from the step b) with at least one isocyanate compound comprising at least two isocyanate functional groups, so as to form a three-dimensional cross-linked polymer network;
d) casting the resulting solution from step c) on a substrate; and
e) evaporating to produce a gel polymer electrolyte.

In the present invention, a gel polymer electrolyte is manufactured according to the process by trapping the liquid electrolyte into the three-dimensional cross-linked polymer network comprising at least one urethane moiety bridging at least two fluorinated copolymers.

A third object of the present invention is the use of the gel polymer electrolyte as described above, as a separator and electrolyte in an electrochemical cell.

Another object of the present invention is a lithium electrochemical cell comprising a cathode, an anode, and the present gel polymer electrolyte.

Another object of the present invention is a lithium electrochemical cell comprising a cathode, an anode, and a gel polymer electrolyte produced by a process according to the present invention.

One or more electrochemical cells according to the invention may be fitted with devices, for example a case, terminals, marking, bus bars and protective devices. The assembly formed by the cell(s) and the devices is a battery.

The gel polymer electrolyte according to the invention and the lithium electrochemical cell comprising such gel polymer electrolyte are promising for the portable and wearable electronics, because of the flexibility and elasticity of the gel polymer electrolyte, which can also be beneficial in adapting the volume change of electrodes. They are also well suited as a source of electric energy in an electric vehicle.

The following constituents of the electrochemical cell according to the invention are described hereafter in details. It is to be understood that both the foregoing general description and the following detailed description are exemplary and are intended to provide further explanation of the invention claimed. Accordingly, various changes, modifications, described herein will be apparent to those of ordinary skill in the art. Moreover, descriptions of well-known functions and constructions may be omitted for the sake of clarity and conciseness.

In the present invention, the term “anode” is intended to denote, in particular, the electrode of an electrochemical cell, where oxidation occurs during discharging. An anode comprises an anode active material which is capable of storing and releasing lithium ions.

In the present invention, the term “cathode” is intended to denote, in particular, the electrode of an electrochemical cell, where reduction occurs during discharging. The cathodic active material is not particularly limited. It can be any cathodic active material known in the art of lithium electrochemical cells. It can be a lithium transition metal oxide (LiMO₂, where M is at least one transition metal), a lithium transition metal phosphate (LiMPO₄, where M is at least one transition metal) or a lithium transition metal fluorosilicate (LiM-SiO—F_{y}, where M is at least one transition metal).

Lithium transition metal oxides contain at least one metal selected from the group consisting of Mn, Co, Cr, Fe, Ni, V, and combinations thereof. For example, the following lithium transition metal oxides may be used in the cathode: LiₐCoO₂ (0.5<a<1.3), LiₐMnO₂ (0.5<a<1.3), LiMn₂O₄ (0.5<a<1.3), Li₂Cr₂O₇, Li₂CrO₄, LiₐNiO₂ (0.5<a<1.3), LiFeO₂, LiₐNi₁₋ₓCo₁₋ₓO₂ where 0.5<a<1.3, 0≤x<1, LiₐCo₁₋ₓMnₓO₂, where 0.5<a<1.3, 0<x<1, LiₐNi₁₋ₓMnₓO₂ where 0.5<a<1.3, 0<x<1, which includes LiMnO_{0.5}NiO_{0.5}O₂, LiMc_{0.5}Mn_{1.5}O₄, wherein Mc is a divalent metal, and LiNiₓCo_{y}Me_{z}O₂ wherein Me may be one or more of Al, Mg, Ti, B, Ga, and Si and 0<x,y,z<1.

In one embodiment, the cathodic electrochemically active material is a compound having the formula Liₐ(NiₓMn_{y}Co_{z})O₄, where 0.5<a<1.3; 0<x<2; 0<y<2; 0<z<2 and x+y+z=2.

A first preferred cathodic electrochemically active material is a compound having the formula: LiₐMO₂, where M refers to NiₓMn_{y}Co_{z}M′ₜ where 0.5<a<1.3; x>0; y>0; z>0: t≥0 and x+y+z+t=1; M′ being selected from the group consisting of B, Mg, Al, Si, Ca, Ti, V, Cr, Fe, Cu, Zn, Y, Zr, Nb, Mo or a mixture thereof.

In one embodiment, a=1, t=0 and x=⅓, y=⅓ and z=⅓.

In one embodiment, a=1, t=0, x=0.8, y=0.1 and z=0.1.

In one embodiment, a=1, t=0, x=0.6, y=0.2 and z=0.2.

A second preferred cathodic electrochemically active material is a spinel type compound having formula LiₐMn₂₋ₓMₓO₄ where M is selected from the group consisting of B, Mg, Al, Si, Ca, Ti, V, Cr, Fe, Co, Ni, Cu, Zn, Y, Zr, Nb and Mo; and 0.5<a<1.3, 0≤x≤2. In one embodiment, M is Ni, a=1, 0≤x≤0.7, preferably 0≤x≤0.5.

According to one embodiment, the electrochemical cell further comprises at least one cathode the electrochemically active material of which is selected from the group consisting of:
LiₐNiₓMn_{y}Co_{z}O₂, where x+y+z=1 and 0.5<a<1.3;
LiₐCoO₂, where 0.5<a<1.3; and
LiₐMn₂₋ₓNiₓO₄, where 0≤x≤0.5 and 0.5<a<1.3.

Lithium transition metal phosphate encompasses compounds of formula LiₐMPO₄ where 0.5<a<1.3 and M is selected from the group consisting of Fe, Mn, Co, Ni, Cu, Zn, Mg, Cr, V, Mo, Ti, Al, Nb and Ga. One example is LiMnₓMc_{y}PO₄, where Mc may be one metal selected from Fe, V, Ni, Co, Al, Mg, Ti, B, Ga, or Si and 0<x,y<1.

A possible cathodic active material is a compound having the formula xLiMO₂₋₍₁₋ₓ₎Li₂M′O₃, where 0<x<1, M includes at least one metal element having an average oxidation number of +3 and includes at least one Ni element, and M′ includes at least one metal element having an average oxidation number of +4.

Furthermore, transition metal oxides such as MnO₂ and V₂O₅, transition metal sulfides such as FeS₂, MoS₂, and TiS₂, and conducting polymers such as polyaniline and polypyrrole may be used.

The structure of the cathode described herein is not particularly limited. The cathode is typically obtained by disposing the cathode electrode material on a current collector. To improve the adhesion of the particles of active material therebetween and the adhesion of the particles to the current collector, the cathode electrode material is generally mixed with a binder. Further, a conductive carbon is generally added in order to improve the electrical conductivity. A cathode paste is thereby obtained.

The binder and the conductive carbon are known in the art. Suitable binders include polyvinylidene fluoride (PVDF), styrene-butadiene rubber (SBR), cellulose, polyamide, melamine resin or a mixture thereof. Binders made of PVDF are preferred for the cathode. A commercially available PVDF binder is Solef®5130. Depending on the characteristics of the binder, the binder is preferably present in an amount of 1 to 9 wt % based on the total weight of the cathode paste. The binder is preferably present in the cathode paste in an average amount of 5 wt % or less based on the total weight of the cathode paste.

The conductive carbon is not particularly limited. Suitable conductive carbons include acetylene black. A commercially available carbon black is Super P® available from Alfa Aesar. Depending on the characteristics of the conductive carbon, the conductive carbon is preferably present in an amount of 1 to 10 wt % based on the total weight of the cathode paste. The conductive carbon is preferably present in an average amount of 5 wt % or less based on the total weight of the cathode paste.

The cathode current collector is a metallic foil, preferably made of aluminum or of an aluminum alloy.

One or more electrochemical cells according to the invention may be fitted with devices, for example a case, terminals, marking, bus bars and protective devices. The assembly formed by the electrochemical cell(s) and the devices corresponds to a battery.

The electrochemical cell and the battery according to the invention exhibit a long life when used in cycling conditions. They are thus well suited as a source of electric energy in an electric vehicle.

Should the disclosure of any pantets, patent applications and publications which are incorporated herein by reference conflict with the description of the present application to the extent that it may render a term unclear, the present description shall take precedence.

The invention is now described with reference to the following examples whose purpose is merely illustrative and not limitative of the present invention.

### EXAMPLES

The coin electrochemical cells of the 2032-type were prepared for the Inventive Example of E1 and Comparative Examples of CE1-CE2. E1 used a gel polymer electrolyte prepared according to the present invention, while CE1 used a hybrid polymer electrolyte system, i.e., a hybrid inorganic-organic polymer which contains TEOS (hybrid VDF-HEA/silica composite, as disclosed in US2013/0023620) and CE2 used conventional liquid electrolyte. The tests were made with coin cells prepared from the same cathode and anode.

A. Preparation of Membrane

All reactants were in an anhydrous condition and stored in a dry room (maximum—45 □ of dew point). The liquid electrolyte was prepared in an argon-filled glove box.

17.0 g of acetone was added in a vial containing 3.003 g of a fluorinated copolymer (PVDF-co-HEA-co-HFP, i.e., Solef® available from Solvay Specialty Polymers) and the solution was heated to 50 □ for 30 mins to complete the dissolution of the fluorinated copolymer (Solution I).

0.245 mg of MDI and 2.0 g of acetone were mixed in a separate vial and heated to 50 □ for 15 mins in a dry room so as to dissolve MDI in acetone (Solution II).

Solution II was then added into Solution I and the liquid electrolyte was incorporated into the mixture of Solution I and Solution II. It was kept at 60 □ for from 1 hour to 4 hours in the dry room, and cooled down to room temperature.

The resulting solution was cast onto a PET substrate to generate a thin-film membrane by coating on a coating table with 250 μm of humid thickness. Subsequently, the thin-film membrane was placed in an oven for 5 to 15 mins at 60 □ (thickness: 40 μm) and stored in a sealed package.

The contents of each component in the resulting membrane were as below in Table 1:

TABLE 1

| | wt % in total weight |
|---|---|
| Components | of the membrance |
| Fluorinated copolymer: | 24.75 |
| PVDF-co-HEA-co-HFP | |
| MDI | 1.00 |
| Liquid Electrolyte: | 74.25 |
| Li salt in EC/PC (1:1 vol %) and VC (2 wt %) | |

PVDF: polyvinylidene fluoride
HEA: 2-hydroxyethyl acrylate
HFP: hexafluoropropylene
MDI: methylene diphenyl diisocyanate
EC: ethylene carbonate
PC: propylene carbonate
VC: vinylene carbonate
Li salt: LiPF₆ (lithium hexafluorophosphate) in 1 mol · L⁻¹

B. Preparation of Electrodes

1. Cathode (NMC111)

All reactants were dried under vacuum at 60° C. (for polymer) and 100° C. (for cathodic active material). The cathodic active material was a nickel-manganese-cobalt oxide of formula LiNi_{1/3}Mn_{1/3}Co_{1/3}O₂ (NMC111).

This cathodic active material was mixed with a conductive carbon and a binder to form a positive paste. The conductive carbon was carbon black (Super-P®). The binder was made of polyvinylidene fluoride (Solef®75130) and was dissolved into acetone at 8 wt %. The cathodic active material, the conductive carbon and the binder accounted respectively for 75.9 wt %, 6.4 wt % and 2.5 wt % of the total weight of the cathode paste, where 15.2 wt % of liquid electrolyte was added. Same liquid electrolyte was used as in preparing the gel membrane, i.e., Li salt in EC/PC (1:1 vol %) and VC (2 wt %).

The cathode slurry was deposited on an aluminum current collector at a loading level of 2.5+0.6 mAh/cm² to form a cathode. The cathode was kept at room temperature for 20 min to evaporate the excess of acetone. 2. Anode (Graphite)

All reactants were dried under vacuum at 60° C. (for polymer) and 100° C. (for anodic active material). Graphite mix of 75% SMG HE2-20 (Hitachi Chemical Co., Ltd.)/25% TIMREXe SFG 6 was used as anodic active material and other reactants of binder, conductive carbon and liquid electrolyte were the same as used in preparing cathode. The anode active material, the conductive carbon and the binder accounted respectively for 69.9 wt %, 0.7 wt % and 2.9 wt % of the total weight of the cathode paste, where 26.47 wt % of liquid electrolyte was added.

All reactants were mixed homeogenously and the resultant anode slurry was deposited on an copper current collector at a loading level of 2.7+0.3 mAh/cm² to form an anode.

C. Assembly of the Coin Cells:

1. E1

The GPE membrane was prepared according to the present invention and placed between the cathode and the anode in a glove box. The separator was not introduced. This assembly was then cut into the dimensions corresponding to a 2032-type coin cell.

2. CE1 and CE2

The same cathode and anode were used, whereas CE1 was prepared with a hybrid polymer electrolyte system comprising liquid electrolyte into a network of organic (polymeric) part (VDF-HEA copolymer) and inorganic part (SiO₂ from TEOS) and CE2 was prepared by assembling same electrodes and a separator (PE Separator available from Tonen Corp., 25 μm thickness) with liquid electrolyte (EC/PC formulation).

D. Electrical Test: Charge-Discharge Test (Cycle Performance)

The cycling ability of each cell was evaluated. Each cell was first subjected to an electrical test comprising a series of about 22 charge-discharge cycles carried out at different C-rate from 0.1C to 2C for the purpose of measuring the capacity retention at different power of the cell. Then, each cell was subjected to a repetition of cycles of charge and discharge (100 cycles at 1C/1C+5 cycles at 0.1C/0.1C). One cycle consisted in a charging phase at a charging specific C-rate followed by a discharge phase at a discharge at the same C-rate.

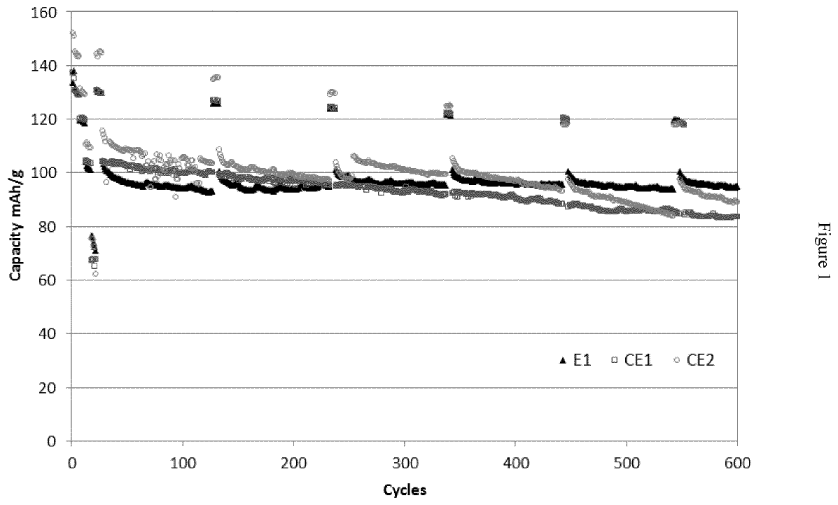

FIG. 1 shows the variation of the capacity of E1 and CE1-CE1 as a function of the cycle number.

Notably, it was observed that E1 showed comparable capacity since the beginning in comparison with CE1 and CE2 (FIG. 1). In particular, the capacity of E1 exceeded that of CE1 after around 150 cycles and continued to keep this superiority. Further, one can note that the even the discrepancy of capacity there between increased more and more, as the number of cycles increased. Similar observation was made with CE2.

E. Mechanical Property Test: Young's Modulus

Young's modulus is a mechanical property which measures the stiffness of a solid material. In particular, the elastic modulus or in other words storage modulus (E′) characterizes the reversible deforming of materials, which relates to the ability to store energy. In addition, the viscous modulus (E″) characterizes the ability of a material to disspipate energy.

The elastic modulus (E′) and the viscous modulus (E″) were measured with E1 and CE1 according to dynamic mechanical analysis (DMA). The specimens of E1 and CE1 in 40 mm*5 mm of dimension per each (thickness: 50 μm) were taken from the thermally sealed package just before the measurement, then held to an ambient temperature (21° C.) and tested at varying frequency from 0.01 Hz up to 12 Hz, while applying 10 g as axial force to the specimen. The elastic modulus (E′) and the viscous modulus (E″) measured at 1 Hz and 10 Hz were recorded in Table 2 as below:

TABLE 2

| | E1 (MPa) | CE1 (MPa) |
|---|---|---|
| E′ (at 1 Hz) | 6.9 | 1.78 |
| E″ (at 10 Hz) | 7.9 | 1.18 |
| E′ (at 1 Hz) | 0.65 | 0.11 |
| E″ (at 10 Hz) | 0.42 | 0.02 |

It was clearly demonstrated that E′ of E1 was much higher than E′ of CE1. Further, one can note that E1 with higher E″ than CE1 with lower E″ may prevent thermal runaway, which is one of key concerns in battery field.

1. A gel polymer electrolyte for a lithium electrochemical cell comprising:
a) a three-dimensional cross-linked polymer network within a liquid electrolyte obtained by forming a reaction product of at least one fluorinated copolymer with at least one isocyanate compound comprising at least two isocyanate functional groups, and b) a liquid electrolyte solution included in the polymer network a),
wherein the fluorinated copolymer comprises
i) at least one first recurring unit derived from at least one ethylenically unsaturated fluorinated monomer; and
ii) at least one second recurring unit derived from at least one ethylenically unsaturated monomer having a hydroxyl group.

2. The gel polymer electrolyte according to claim 1, wherein the polymer network a) comprises at least one urethane moiety bridging at least two fluorinated copolymers.

3. The gel polymer electrolyte according to claim 1, wherein the first recurring unit i) is derived from vinylidene fluoride (VDF), chlorotrifluoroethylene (CTFE), hexafluoropropylene (HFP), tetrafluoroethylene (TFE), trifluoroethylene, or combinations thereof.

4. The gel polymer electrolyte according to claim 1, wherein the second recurring unit ii) is derived from an (meth)acrylic acid ester having a hydroxyl group.

5. The gel polymer electrolyte according to claim 4, wherein the (meth)acrylic acid ester having a hydroxyl group comprises an acrylate selected from the group consisting of 2-hydroxyethyl acrylate (HEA), 2-hydroxyethyl methacrylate, 2-hydroxymethyl acrylate, 2-hydroxymethyl methacrylate, 2-hydroxypropyl acrylate, 2-hydroxypropyl methacrylate, 2-hydroxybutyl acrylate, 2-hydroxybutyl methacrylate, 4-hydroxybutyl acrylate, 4-hydroxybutyl methacrylate, 6-hydroxyhexyl acrylate, 6-hydroxyhexyl methacrylate, 8-hydroxyoctyl acrylate, 8-hydroxyoctyl methacrylate, 2-hydroxyethyleneglycol acrylate, 2-hydroxyethlyeneglycol methacrylate, 2-hydroxypropyleneglycol acrylate, 2-hydroxypropyleneglycol methacrylate, 2,2,2-trifluoroethyl acrylate, and 2,2,2-trifluoroethyl methacrylate.

6. The gel polymer electrolyte according to claim 1, wherein the at least one isocyanate compound comprising at least two isocyanate functional groups comprises a compound selected from the group consisting of 2,4-tolylenediisocyanate, 2,6-tolylenediisocyanate, xylylenediisocyanate, isophoronediisocyanate, methylene bis(4-phenyl isocyanate), methyl cyclohexyldiisocyanate, trimethyl hexamethylene diisocyanate, hexamethylene diisocyanate, naphthalene-1,5-diisocyanate, and poly(ethylene adipate)-tolylene-2,4-diisocyanate.

7. The gel polymer electrolyte according to claim 1, wherein the liquid electrolyte solution b) comprises
at least one lithium salt; and
a liquid medium comprising at least one organic carbonate compound.

8. The gel polymer electrolyte according to claim 7, wherein the at least one lithium salt comprises a salt selected from the group consisting of lithium hexafluorophosphate (LiPF₆), lithium bis(fluorosulfonyl)imide Li(FSO₂)₂N (LiFSI), lithium trifluoromethane sulfonate (LiCF₃SO₃), LiN(SO₂CₘF₂ₘ₊₁)(SO₂CₙF₂ₙ₊₁) and LiC(SO₂CₖF₂ₖ₊₁)(SO₂CₘF₂ₘ₊₁)(SO₂CₙF₂ₘ₊₁) wherein k=1-10, m=1-10 and n=1-10, LiN(SO₂CₚF₂ₚSO₂) and LiC(SO₂CₚF₂ₚSO₂)(SO₂C_{q}F_{2q+1}) wherein p=1-10 and q=1-10, and mixtures thereof.

9. The gel polymer electrolyte according to claim 7, wherein the at least one organic carbonate compound comprises a carbonate selected from the group consisting of ethylene carbonate (1,3-dioxalan-2-one), propylene carbonate, 4-methylene-1,3-dioxolan-2-one, 4,5-dimethylene-1,3-dioxolan-2-one, dimethyl carbonate, diethyl carbonate, ethyl methyl carbonate, butylene carbonate, fluoroethylene carbonate, fluoropropylene carbonate, and mixtures thereof.

10. The gel polymer electrolyte according to claim 1, wherein the liquid electrolyte solution b) further comprises at least one additive.

11. The gel polymer electrolyte according to claim 10, wherein the additive is a film-forming additive.

12. A process for the manufacture of the gel polymer electrolyte for a lithium electrochemical cell according to claim 1, said process comprising the steps of:
a) dissolving at least one fluorinated copolymer in a volatile solvent;
b) mixing the dissolved polymer solution with a liquid electrolyte;
c) reacting the resulting solution from the step b) with at least one isocyanate compound comprising at least two isocyanate functional groups, so as to form a three-dimensional cross-linked polymer network;
d) casting the resulting solution from the step c) on a substrate; and
e) evaporating to produce a gel polymer electrolyte.

13. The gel polymer electrolyte according to claim 1, being a separator and an electrolyte in an electrochemical cell.

14. A lithium electrochemical cell comprising
a cathode;
an anode; and
the gel polymer electrolyte according to claim 1.

15. A lithium electrochemical cell comprising
a cathode;
an anode; and
a gel polymer electrolyte,
wherein the gel polymer electrolyte is produced by the process according to claim 12.
